(19) United States
(12) Patent Application Publication
(10) Pub. No.: US 2025/0391987 A1
(43) Pub. Date: Dec. 25, 2025

(54) TRACTION BATTERY PACK CELL STACK DIVIDER ASSEMBLY

(71) Applicant: Ford Global Technologies, LLC, Dearborn, MI (US)

(72) Inventors: Jie Deng, Novi, MI (US); Brian Utley, Canton, MI (US); Mihir Devendra Upadhye, Ann Arbor, MI (US); Daniel Paul Roberts, Livonia, MI (US)

(21) Appl. No.: 18/747,643

(22) Filed: Jun. 19, 2024

(51) Int. Cl. H01M 50/293; H01M 10/613; H01M 10/6567; H01M 50/211; H01M 50/249; H01M 50/291

(52) U.S. Cl. CPC H01M 50/293; H01M 10/613; H01M 10/6567; H01M 50/211; H01M 50/291; H01M 50/249

(57) ABSTRACT

A traction battery pack assembly includes an enclosure and a cell stack within an interior of the enclosure. The cell stack includes battery cells and divider assemblies disposed along a cell stack axis. The divider assemblies are each sandwiched along the axis between a first battery cell and a second battery cell. The divider assemblies each interface with an axially facing side of the first battery cell and an axially facing side of the second battery cells to support the battery cells at a position spaced from the enclosure.

### TECHNICAL FIELD

This disclosure details exemplary assemblies and methods that involve supporting battery cells of a cell stack using divider assemblies of the cell stack and, more particularly, to divider assemblies that support the battery cells in a way that establishes areas for coolant flow.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. As part of an immersion thermal management system, liquid coolant can be moved through the traction battery pack to help manage thermal energy within the traction battery pack.

### SUMMARY

In some aspects, the techniques described herein relate to a traction battery pack assembly, including: an enclosure; and a cell stack within an interior of the enclosure, the cell stack including a plurality of battery cells and a plurality of divider assemblies disposed along a cell stack axis, the plurality of divider assemblies each sandwiched along the axis between a first battery cell and a second battery cell within the plurality of battery cells, the plurality of divider assemblies each interfacing with an axially facing side of the first battery cell and an axially facing side of the second battery cells to support the plurality of battery cells at a position spaced from the enclosure.

In some aspects, the techniques described herein relate to a traction battery pack assembly, wherein the plurality of divider assemblies are each aluminum.

In some aspects, the techniques described herein relate to a traction battery pack assembly, wherein supporting the plurality of battery cells at a position spaced from the enclosure establishes at least one immersion coolant channel between the plurality of battery cells and the enclosure.

In some aspects, the techniques described herein relate to a traction battery pack assembly, further including a liquid coolant within the at least one immersion coolant channel.

In some aspects, the techniques described herein relate to a traction battery pack assembly, wherein the plurality of battery cells are a plurality of pouch-style battery cells.

In some aspects, the techniques described herein relate to a traction battery pack assembly, wherein the plurality of divider assemblies each support the plurality of battery cells without interfacing with a radially facing side of the first battery cell or a radially facing side of the second battery cell.

In some aspects, the techniques described herein relate to a traction battery pack assembly, wherein the plurality of divider assemblies are each compressed between the first battery cell and the second battery cell along the cell stack axis.

In some aspects, the techniques described herein relate to a traction battery pack assembly, wherein the plurality of divider assemblies each have a C-shaped cross-section.

In some aspects, the techniques described herein relate to a traction battery pack assembly, wherein the plurality of divider assemblies each include a sandwiched portion and at least one peripheral portion, the sandwiched portion sandwiched axially between the first battery cell and the second battery cell, the at least one peripheral portion extending radially from the cell stack axis past the first battery cell and the second battery cell.

In some aspects, the techniques described herein relate to a traction battery pack assembly, wherein the at least one peripheral portion is received within a groove of the enclosure.

In some aspects, the techniques described herein relate to a traction battery pack assembly, wherein the at least one peripheral portion includes a first peripheral portion that extends above the first battery cell and the second battery cell, and a second peripheral portion that extends below the first battery cell and the second battery cell.

In some aspects, the techniques described herein relate to a traction battery pack assembly, wherein enclosure includes an enclosure cover and an enclosure tray, the first peripheral portion at least partially received within a groove of the enclosure cover, the second peripheral portion at least partially received within a groove of the enclosure tray.

In some aspects, the techniques described herein relate to a method of managing thermal energy within a traction battery pack, including: immersing at least a portion of a cell stack within a liquid coolant to manage thermal energy within the cell stack, the cell stack including a plurality of battery cells disposed along a cell stack axis and a plurality of divider assemblies disposed along the cell stack axis, the cell stack housed within an enclosure; and using frictional forces between the plurality of battery cells and the plurality of divider assemblies to support the plurality of battery cells at a position spaced from the enclosure to establish an area for the liquid coolant to flow between the plurality of battery cells and the enclosure.

In some aspects, the techniques described herein relate to a method, wherein the plurality of divider assemblies each include a sandwiched portion and at least one peripheral portion, the sandwiched portion sandwiched axially between a first battery cell and a second battery cell within the plurality of battery cells, the at least one peripheral portion extending radially from the cell stack axis past the plurality of battery cells.

In some aspects, the techniques described herein relate to a method, wherein the at least one peripheral portion includes a first peripheral portion that extends above the plurality of battery cells of the cell stack, and a second peripheral portion that extends below the plurality of battery cells of the cell stack.

In some aspects, the techniques described herein relate to a method, further including supporting the plurality of battery cells using contact between the sandwiched portion and an axially facing side of the first battery cell, and using contact between the sandwiched portion an axially facing side of the second battery cell.

In some aspects, the techniques described herein relate to a method, further including supporting the plurality of battery cells using the plurality of divider assemblies without relying on contact between the plurality of divider assemblies and any side of the plurality of battery cells that faces away from the cell stack axis.

In some aspects, the techniques described herein relate to a method, further including communicating a liquid coolant through the area between the plurality of battery cells and the enclosure.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective, schematic view of the battery pack of FIG. 1

FIG. 3 illustrates a section view at line 3-3 in FIG. 2 showing a cell stack of the battery pack within an enclosure of the battery pack where the cell stack has a plurality of divider assemblies that support battery cells at a position spaced from parts of the enclosure.

FIG. 4 illustrates a close-up view of an area of FIG. 3.

FIG. 5 illustrates a close-up view of another area of FIG. 3.

FIG. 6 illustrates a perspective, schematic view of a battery cell from the cell stack of FIG. 2.

FIG. 7 illustrates a view of a portion of a battery pack having a divider assembly for a cell stack according to another exemplary aspect of the present disclosure.

FIG. 8 illustrates a view of a portion of a battery pack having a divider assembly for a cell stack according to yet another exemplary aspect of the present disclosure.

FIG. 9 illustrates a view of a portion of a battery pack having a divider assembly for a cell stack according to yet another exemplary aspect of the present disclosure.

FIG. 10 illustrates a view of a portion of a battery pack having a divider assembly for a cell stack according to yet another exemplary aspect of the present disclosure.

### DETAILED DESCRIPTION

An immersion thermal management system can be used to manage thermal energy in a traction battery pack. The immersion thermal management system immerses at least some components, such as battery cells, of the traction battery pack in a liquid coolant. This disclosure is directed toward supporting the battery cells in a way that provides space for the liquid coolant to move through the traction battery pack.

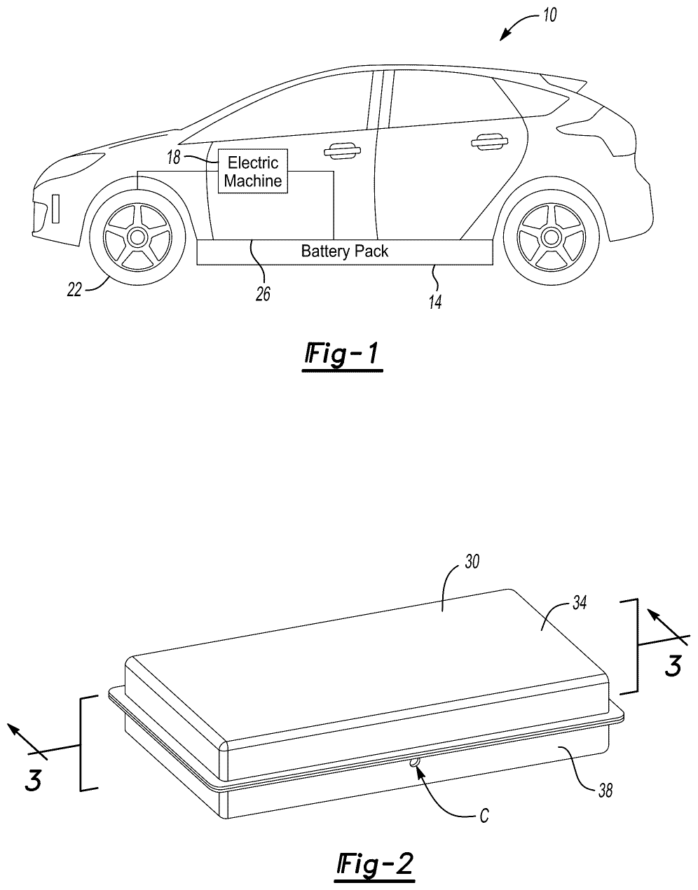

With reference to FIG. 1, an electrified vehicle 10 includes a traction battery pack 14, an electric machine 18, and wheels 22. The traction battery pack 14 powers an electric machine 18, which can convert electrical power to mechanical power to drive the wheels 22. The traction battery pack 14 can be a relatively high-voltage battery.

The traction battery pack 14 is, in the exemplary embodiment, secured to an underbody 26 of the electrified vehicle 10. The traction battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

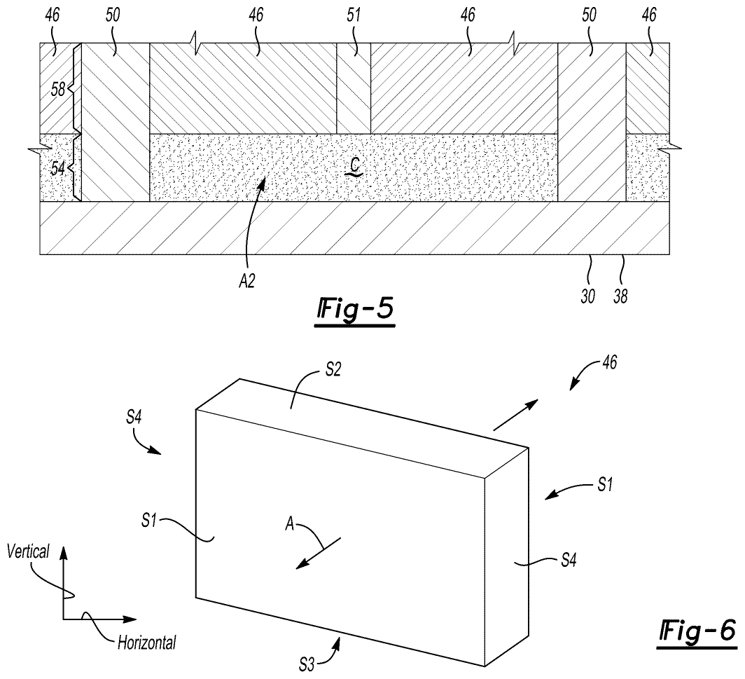

Referring now to FIGS. 2-5, the battery pack 14 includes an enclosure assembly 30 having a cover 34 and a tray 38. The cover 34, in this example, is vertically above the tray 38. In other examples, however, the cover 34 could be arranged below, or to a side of the tray 38.

Vertical is with reference to ground and a general orientation of the vehicle 10 and the battery pack 14 during operation. Various terms such as “above,” “below,” “top,” and “bottom” are used relative to the arrangement of the components of the battery pack 14 in the various drawings and should not otherwise be deemed limiting. These terms are with reference to the general orientation of the battery pack 14 when installed within the vehicle 10 of FIG. 1.

The cover 34 is welded to the tray 38 in one example of this disclosure. While welding is mentioned, the cover 34 and tray 38 could be connected using other fluid-tight connection techniques, such as adhesive. Further, while an exemplary enclosure assembly 30 is shown in the drawings, the enclosure assembly 30 may vary in size, shape, and configuration within the scope of this disclosure.

In this disclosure, at least one cell stack 42 is housed within the enclosure assembly 30. The cell stack 42 includes a plurality of individual battery cells 46 disposed along a cell stack axis A. The cell stack 42 could include any number of battery cells 46. The battery pack 14 could also employ any number of cell stacks 42 within the enclosure assembly 30. Thus, this disclosure is not limited to the exact configuration shown in FIG. 2. Further, while the battery cells 46 of FIG. 2 are positioned side-by-side relative to one another along the cell stack axis A, other configurations are also contemplated within the scope of this disclosure, including but not limited to embodiments in which the battery cells 46 are stacked on top of one another, for example.

The cell stack 42 is arranged in an interior of the enclosure assembly 30 between the tray 38 and beneath the cover 34. A thermal management system is configured to route non-conductive (i.e., dielectric) coolant C through the interior and over areas of the cell stack 42 to manage thermal energy within the cell stack 42 by, for example, using the coolant C to take on heat from the cell stack 42. The thermal management system is an immersion thermal management system at least because portions of the battery pack 14, here at least the battery cells 46 of the cell stack 42 are immersed in the coolant C. In an example, the coolant C takes on thermal energy from components within the interior of the enclosure assembly 30 and is then routed to, for example, a heat exchanger outside the battery pack 14. At the heat exchanger, thermal energy is release from the coolant C. The coolant C is then recirculated back through the interior.

The cell stack 42 further includes a plurality of divider assemblies 50 disposed axially between groups of the battery cells 46 along the cell stack axis A. The cell stack additionally includes a plurality of spacers 51, which can be foam, for example.

The plurality of divider assemblies 50 each include a sandwiched portion 54 and at least one peripheral portion 58. The sandwiched portions 54 are sandwiched axially between axially adjacent battery cells 46. The at least one peripheral portions 58 extend radially outward from the sandwiched portions 54 relative to the cell stack axis A and are disposed outside the battery cells 46 relative to the cell stack axis A.

The example divider assemblies 50 include one peripheral portion 58 extending upward above the battery cells 46 and one peripheral portion 58 extending downward below the battery cells 46. In other examples, the divider assemblies 50 could include a single peripheral portion 58 extending downward.

The spacers 51, in this example, do not extend above and below the battery cells 46 in this example.

The sandwiched portion 54 and the peripheral portions 58 are parts a singular divider assembly structure. The divider assemblies 50 can be a metal or metal alloy. More specifically, the divider assemblies 50 could be aluminum. In another example, the divider assemblies 50 could be a foam that is relatively rigid.

The divider assemblies 50 support the plurality of battery cells 46, and the cell stack 42, at a position spaced from the enclosure assembly 30. In this example, the divider assemblies 50 support the plurality of battery cells 46 such that the battery cells 46 are spaced beneath the enclosure cover 34 to establish an area A1 for communicating the coolant C over top sides of the battery cells 46. The top side of the battery cells 46 face upward away from the cell stack axis A.

The example divider assemblies 50 further support the battery cells 46 such that the battery cells 46 are elevated above the enclosure tray 38 to establish an area A2 for communicating the liquid coolant over the bottom sides of the battery cells 46. The bottom sides of the battery cells 46 face downward away from the cell stack axis A.

The areas A1 and A2 established by spacing the battery cells 46 from the enclosure cover 34 and the enclosure tray 38 effectively establishes immersion coolant channels between the enclosure assembly 30 and the plurality of battery cells 46.

Notably, the example divider assemblies 50 support the battery cells 46 by interfacing with axially facing sides of the plurality of battery cells 46. The battery cells 46 and the sandwiched portions 54 are compressed against each other along the cell stack axis A, and frictional forces between the plurality of battery cells 46 and the sandwiched portions 54 of the divider assemblies 50 allow the divider assemblies 50 to support the plurality of battery cells 46 above the enclosure tray 38. The frictional forces block the plurality of battery cells 46 from dropping down to the enclosure tray 38. The example divider assemblies 50 support the battery cells 46 without the divider assemblies 50 interfacing with the bottom sides of the battery cells 46. The example divider assemblies 50 support the plurality of battery cells 46 without interfacing directly with any sides of the plurality of battery cells 46 that face radially outward away from the cell stack axis A.

The plurality of battery cells 46 are thus supported using contact between the sandwiched portions 54 and the axially facing sides of the battery cells 46. The plurality of battery cells 46 are supported without relying on contact between the divider assemblies 50 and any side of the plurality of battery cells 46 that faces away from the cell stack axis A (i.e., the radially facing sides of the battery cells 46).

FIG. 6 shows a schematic perspective view of one of the battery cells 46 from the cell stack 42. As shown, the battery cells 46 each have opposing axially facing sides S1, a top side S2, a bottom side S3, and opposing laterally facing sides S4. The axially facing sides S1 can be considered broad sides of the battery cells 46 as these sides are broader than the top sides S2, the bottom sides S3, or the laterally facing sides S4.

In an embodiment, the battery cells 46 are pouch-style, lithium-ion cells. However, battery cells having other geometries (cylindrical, prismatic, etc.), other chemistries (nickel-metal hydride, lead-acid, etc.), or both could alternatively be utilized within the scope of this disclosure.

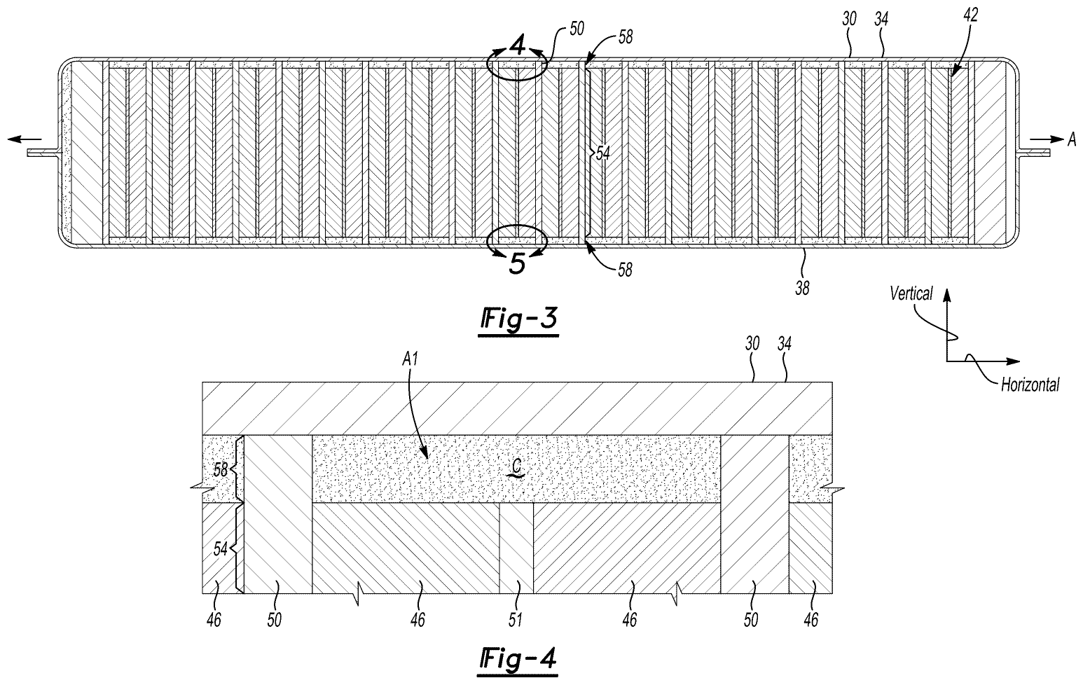

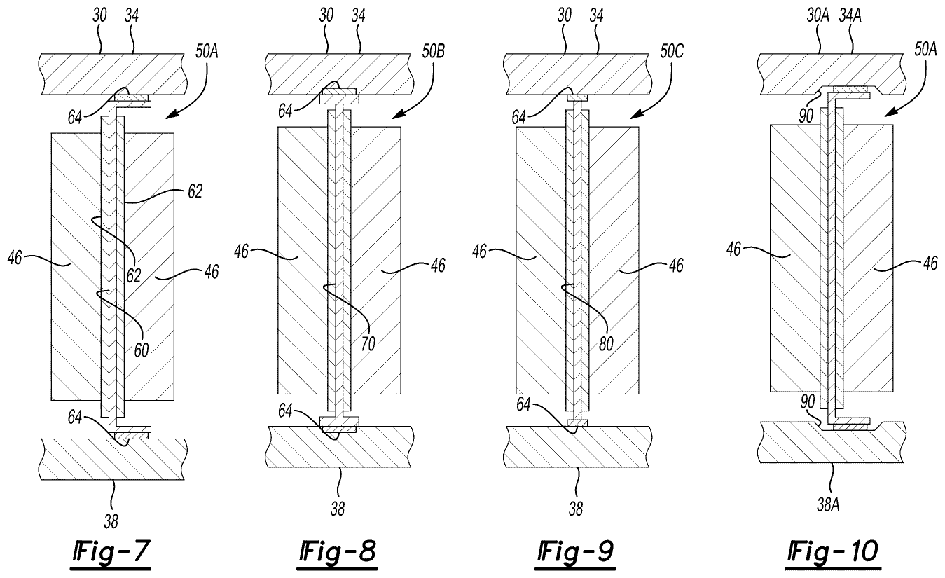

FIG. 7 illustrates a divider assembly 50A according to another exemplary embodiment of the present disclosure. The divider assembly 50A could be used in the cell stack 42 of FIG. 3. The divider assembly 50A has a C-shaped cross-section in this example. The divider assembly 50A includes a fin 60 that is metal or metal alloy sandwiched between layers of foam 62. The foam 62 can be a polyurethane foam. Battery cells 46 on opposing sides of the fin 60 can be adhesively secured to the foam 62 of the divider assembly 50A. The adhesive can be a tape or a spray adhesive, for example. The fin 60 can be can be stamped from a sheet of material. A thermal interface material 64 is positioned where the peripheral areas of the divider assembly 50A interface with the enclosure assembly 30. The thermal interface material 64 can help to address vibration issues and can, as required, seal these interfaces. The thermal interface material 64 can be an adhesive, foam, or other material.

FIG. 8 illustrates a divider assembly 50B according to another exemplary embodiment of the present disclosure. The divider assembly 50B could be used in the cell stack 42 of FIG. 3. The divider assembly 50B has a I-shaped cross-section in this example. The divider assembly 50B has a fin 70 having an I-shape. Like the divider assembly 60A, layers of foam 62 are disposed on opposing sides of the fin 70.

FIG. 9 illustrates a divider assembly 50C according to another exemplary embodiment of the present disclosure. The divider assembly 50C could be used in the cell stack 42 of FIG. 3. The divider assembly 50C has a fin 80 that is substantially planar. Like the divider assembly 50A, layers of foam 62 are disposed on opposing sides of the fin 80. In another example, two fins could sandwich a layer of foam 62.

FIG. 10 illustrates the divider assembly 50A according to another exemplary embodiment of the present disclosure. In this embodiment, the enclosure assembly 30A includes a groove 90 in the enclosure cover 34A and a groove 90 in the enclosure tray 38A. The grooves 90 each receive a portion of the divider assembly 50A. Receiving portions of the divider assembly 50A within the grooves 90 can help to, among other things, maintain alignment of the divider assembly 50A during installation and after installation. The grooves 90 in the enclosure cover 34A, the grooves 90 in the enclosure tray 38A, or both, could be used in connection with any of the divider assemblies 50, 50A, 50B, 50C of this disclosure.

Features of disclosed examples include supporting battery cells of a c ell stack in a way that provides space for coolant flow.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
an enclosure; and
a cell stack within an interior of the enclosure, the cell stack including a plurality of battery cells and a plurality of divider assemblies disposed along a cell stack axis, the plurality of divider assemblies each sandwiched along the axis between a first battery cell and a second battery cell within the plurality of battery cells, the plurality of divider assemblies each interfacing with an axially facing side of the first battery cell and an axially facing side of the second battery cells to support the plurality of battery cells at a position spaced from the enclosure.

2. The traction battery pack assembly of claim 1, wherein the plurality of divider assemblies are each aluminum.

3. The traction battery pack assembly of claim 1, wherein supporting the plurality of battery cells at a position spaced from the enclosure establishes at least one immersion coolant channel between the plurality of battery cells and the enclosure.

4. The traction battery pack assembly of claim 3, further comprising a liquid coolant within the at least one immersion coolant channel.

5. The traction battery pack assembly of claim 1, wherein the plurality of battery cells are a plurality of pouch-style battery cells.

6. The traction battery pack assembly of claim 1, wherein the plurality of divider assemblies each support the plurality of battery cells without interfacing with a radially facing side of the first battery cell or a radially facing side of the second battery cell.

7. The traction battery pack assembly of claim 1, wherein the plurality of divider assemblies are each compressed between the first battery cell and the second battery cell along the cell stack axis.

8. The traction battery pack assembly of claim 1, wherein the plurality of divider assemblies each have a C-shaped cross-section.

9. The traction battery pack assembly of claim 1, wherein the plurality of divider assemblies each include a sandwiched portion and at least one peripheral portion, the sandwiched portion sandwiched axially between the first battery cell and the second battery cell, the at least one peripheral portion extending radially from the cell stack axis past the first battery cell and the second battery cell.

10. The traction battery pack assembly of claim 9, wherein the at least one peripheral portion is received within a groove of the enclosure.

11. The traction battery pack assembly of claim 9, wherein the at least one peripheral portion includes a first peripheral portion that extends above the first battery cell and the second battery cell, and a second peripheral portion that extends below the first battery cell and the second battery cell.

12. The traction battery pack assembly of claim 11, wherein enclosure includes an enclosure cover and an enclosure tray, the first peripheral portion at least partially received within a groove of the enclosure cover, the second peripheral portion at least partially received within a groove of the enclosure tray.

13. A method of managing thermal energy within a traction battery pack, comprising:
immersing at least a portion of a cell stack within a liquid coolant to manage thermal energy within the cell stack, the cell stack including a plurality of battery cells disposed along a cell stack axis and a plurality of divider assemblies disposed along the cell stack axis, the cell stack housed within an enclosure; and
using frictional forces between the plurality of battery cells and the plurality of divider assemblies to support the plurality of battery cells at a position spaced from the enclosure to establish an area for the liquid coolant to flow between the plurality of battery cells and the enclosure.

14. The method of claim 13, wherein the plurality of divider assemblies each include a sandwiched portion and at least one peripheral portion, the sandwiched portion sandwiched axially between a first battery cell and a second battery cell within the plurality of battery cells, the at least one peripheral portion extending radially from the cell stack axis past the plurality of battery cells.

15. The method of claim 14, wherein the at least one peripheral portion includes a first peripheral portion that extends above the plurality of battery cells of the cell stack, and a second peripheral portion that extends below the plurality of battery cells of the cell stack.

16. The method of claim 14, further comprising supporting the plurality of battery cells using contact between the sandwiched portion and an axially facing side of the first battery cell, and using contact between the sandwiched portion an axially facing side of the second battery cell.

17. The method of claim 13, further comprising supporting the plurality of battery cells using the plurality of divider assemblies without relying on contact between the plurality of divider assemblies and any side of the plurality of battery cells that faces away from the cell stack axis.

18. The method of claim 13, further comprising communicating a liquid coolant through the area between the plurality of battery cells and the enclosure.
